(19) United States
(12) Patent Application Publication
(10) Pub. No.: US 2015/0088589 A1
(43) Pub. Date: Mar. 26, 2015

(54) CONVERTING A TEXT OPERATIONAL MANUAL INTO A BUSINESS PROCESS MODEL OR WORKFLOW DIAGRAM

(71) Applicant: International Business Machines Corporation, Armonk, NY (US)

(72) Inventors: Mike A. Marin, Laguna Hills, CA (US); Vivek K. Paramashivappa, Bangalore (IN); Balunaini Prasad, Bangalore (IN)

(73) Assignee: International Business Machines Corporation, Armonk, NY (US)

(21) Appl. No.: 14/037,559

(22) Filed: Sep. 26, 2013

(51) Int. Cl. G06Q 10/06

(52) U.S. Cl. CPC G06Q 10/06316
USPC 705/7.26

(57) ABSTRACT

Embodiments of the present invention disclose a method, computer program product, and system for generating a workflow diagram corresponding to text describing a business process. A computer identifies activities in steps of a business process by parsing text describing the business process. The computer determines activity names associated with the identified activities. The computer identifies roles associated with actors performing the identified activities. The computer identifies a sequence in which the identified activities are executed. The computer generates a workflow diagram of the business process based on the identified activities, determined activity names corresponding to the identified activities, identified roles associated with the identified activities, and the identified sequence in which the identified activities are executed.

### FIELD OF THE INVENTION

The present invention relates generally to the field of data conversion, and more particularly to converting a text operational manual into a workflow diagram.

### BACKGROUND OF THE INVENTION

Operational manuals can be text documents that describe operations of various business processes of an organization. Business process operations are a defined set of actions that are taken in the course of performing an operation of an organization. The operational manuals include textual details corresponding to activities to perform, business roles that perform activities, and description of a workflow for the activities. The business processes can range from a simple task, to a complicated procedure (e.g., a computer-implemented business transaction, purchase of goods on the internet, method of examining water samples, managing a list, etc.).

Business process management (BPM) is a management approach that works to align business processes of an organization with client needs, while promoting an increased effectiveness and efficiency of the organization. Business processes utilized in accordance with BPM can be described in a text operational manual, and depicted in a graphical workflow diagram. BPM graphical workflows diagrams can be depicted utilizing a file format such as XML Process Definition Language (XPDL), Business Process Execution Language (BPEL), and Business Process Model and Notation (BPMN). A BPM graphical workflow diagram is a visual depiction of activities, business roles that perform the activities, and the sequence in which the activities are performed.

### SUMMARY

Embodiments of the present invention disclose a method, computer program product, and system for generating a workflow diagram corresponding to text describing a business process. A computer identifies activities in steps of a business process by parsing text describing the business process. The computer determines activity names associated with the identified activities. The computer identifies roles associated with actors performing the identified activities. The computer identifies a sequence in which the identified activities are executed. The computer generates a workflow diagram of the business process based on the identified activities, determined activity names corresponding to the identified activities, identified roles associated with the identified activities, and the identified sequence in which the identified activities are executed.

### BRIEF DESCRIPTION OF THE SEVERAL VIEWS OF THE DRAWINGS

FIG. 1 is a functional block diagram of a data processing environment in accordance with an embodiment of the present invention.

FIG. 2 is a flowchart depicting operational steps of a program for converting text in an operational manual to a workflow diagram, in accordance with an embodiment of the present invention.

FIG. 3A is an exemplary depiction of a sample business process for collecting water samples, in accordance with an embodiment of the present invention.

FIG. 3B is an exemplary depiction of the sample business process for collecting water samples of FIG. 3A, in which activities of the business process have been identified, in accordance with an embodiment of the present invention.

FIG. 4 is an exemplary depiction of a workflow diagram of the sample business process of FIG. 3A, in accordance with an embodiment of the present invention.

FIG. 5 depicts a block diagram of components of the computing system of FIG. 1 in accordance with an embodiment of the present invention.

### DETAILED DESCRIPTION

Exemplary embodiments of the present invention allow for a conversion of business processes in an operational manual to a workflow diagram. In one embodiment, a text operational manual is automatically processed to identify activities, business roles that perform the activities, and the sequence in which the activities are executed in the operational manual. A standard Business Process Management (BPM) workflow diagram is then determined corresponding to the identified data from the text operational manual.

Embodiments of the present invention recognize that a typical process for graphical modeling of business processes or workflows require an analyst to manually translate textual operational manuals into a BPM workflow diagram or another form of visual representation. Manually converting text operational manuals into executable graphical workflow diagrams is prone to errors, and can be a time consuming process.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

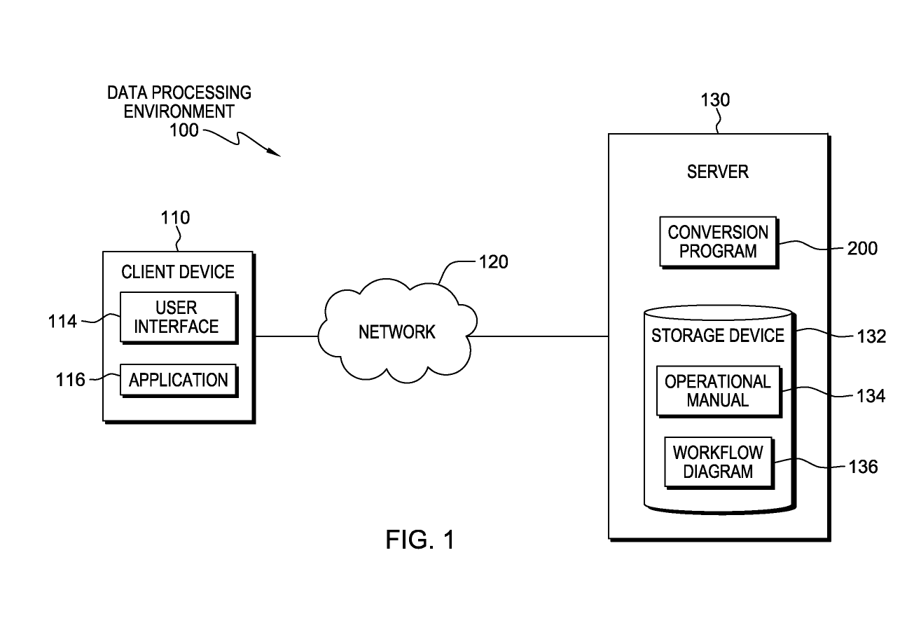

The present invention will now be described in detail with reference to the Figures. FIG. 1 is a functional block diagram illustrating data processing environment 100, in accordance with one embodiment of the present invention.

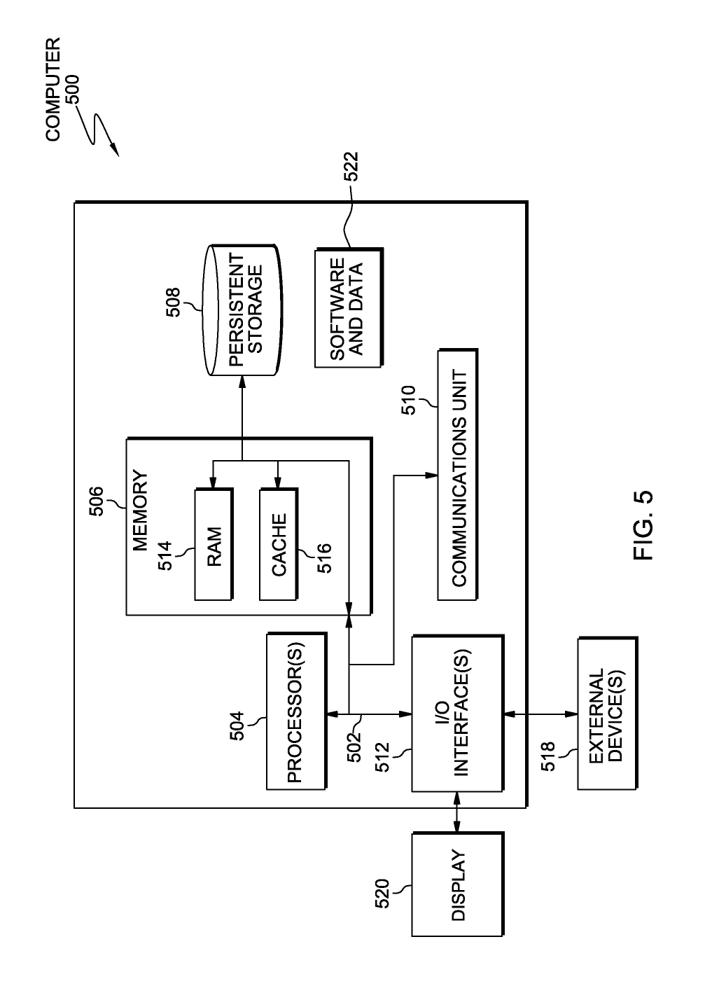

An exemplary embodiment of data processing environment 100 includes client device 110 and server 130, interconnected over network 120. In various embodiments of the present invention, client device 110 may be a workstation, personal computer, personal digital assistant, mobile phone, or any other device capable of executing program instructions in accordance with embodiments of the present invention. In general, client device 110 is representative of any electronic device or combination of electronic devices capable of executing machine-readable program instructions, as described in greater detail with regard to FIG. 5, in accordance with embodiments of the present invention.

Client device 110 includes user interface 114 and application 116. User interface 114 accepts input from individuals utilizing client device 110. In exemplary embodiments, application 116 on client device 110 accesses data stored on server 130. In exemplary embodiments, application 116 receives input from user interface 114, which may be provided by an individual utilizing client device 110.

In one embodiment, client device 110 and server 130 communicate through network 120. Network 120 can be, for example, a local area network (LAN), a telecommunications network, a wide area network (WAN) such as the Internet, or a combination of the three, and include wired, wireless, or fiber optic connections. In general, network 120 can be any combination of connections and protocols that will support communications between client device 110, and server 130 in accordance with embodiments of the present invention.

In one embodiment, server 130 stores information that application 116 on client device 110 can access and utilize. In exemplary embodiments, server 130 can be a desktop computer, computer server, or any other computer system known in the art capable of performing functions in accordance with embodiments of thee present invention. In certain embodiments, server 130 represents computer systems utilizing clustered computers and components (e.g., database server computers, application server computers, etc.) that act as a single pool of seamless resources when accessed by elements of data processing environment 100 (e.g., client device 110). In general, server 130 is representative of any electronic device or combination of electronic devices capable of executing machine-readable program instructions, as described in greater detail with regard to FIG. 5, in accordance with embodiments of the present invention.

Server 130 includes conversion program 200, and storage device 132, which includes operational manual 134 and workflow diagram 136. Storage device 132 can be implemented with any type of storage device, for example, persistent storage 508, which is capable of storing data that may be accessed and utilized by client device 110, and server 130 such as a database server, a hard disk drive, or flash memory. In other embodiments, storage device 132 can represent multiple storage devices within server 130.

In one embodiment, storage device 132 includes one or more instances of operational manual 134 and corresponding instances of workflow diagram 136. Operational manual 134 represents a text document that describes operations of business processes of an organization. Operational manual 134 is in a digital file format (e.g., portable document format (PDF), rich text format (RTF), or other file format), which can be accessed and modified by application 116 on client device 110.

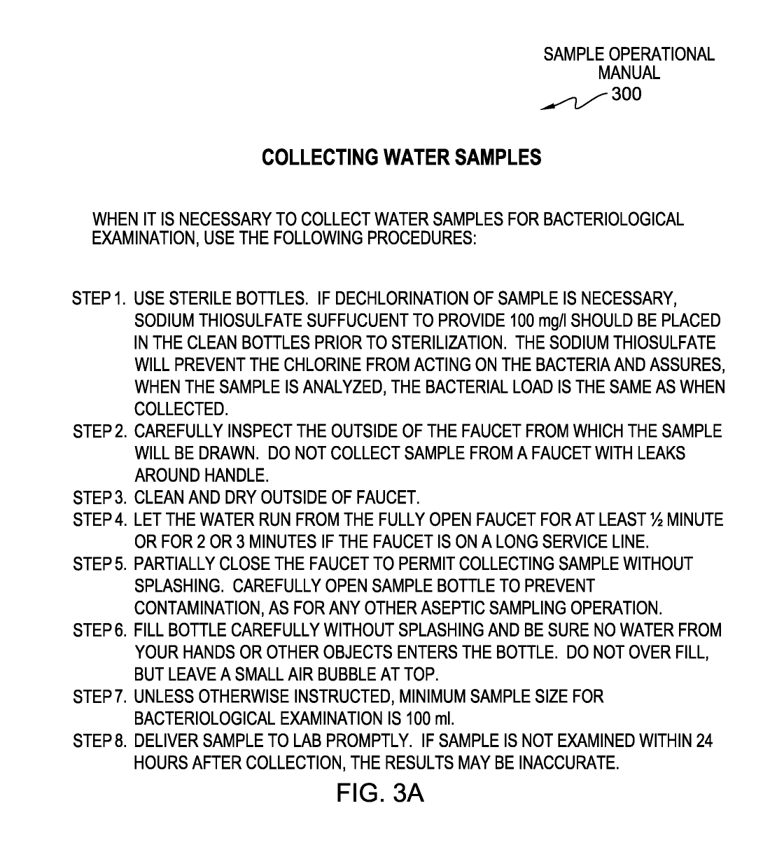

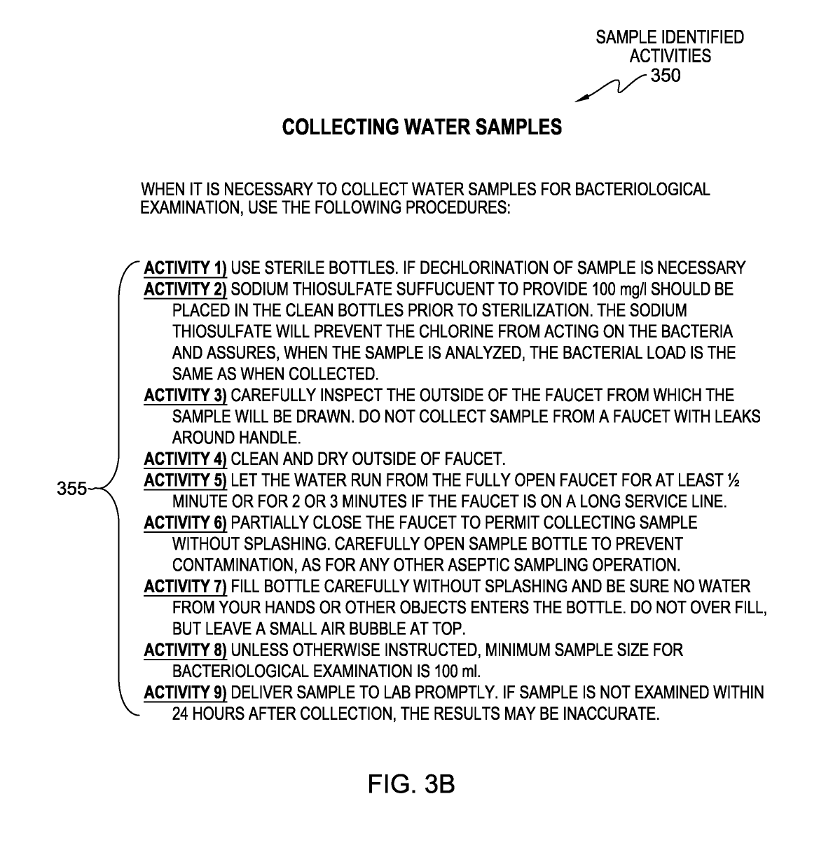

FIG. 3A illustrates sample text of a business process for collecting water samples, which can be included in operational manual 134. In another embodiment, operational manual 134 includes sample operational manual 300, and additional text corresponding to additional business processes. The process outlined in sample operational manual 300 is an excerpt from the U.S. Food and Drug Administration (FDA) Investigations Operations Manual (TOM) (Chapter 4, page 120, section 4.3.6.3, 2012 Version).

Workflow diagram 136 represents a visual representation of a workflow corresponding to a business process described in operational manual 134. In exemplary embodiments, workflow diagram 136 is a Business Process Management (BPM) graphical workflow diagram, which can utilize a file format such as XML Process Definition Language (XPDL), Business Process Execution Language (BPEL), and Business Process Model and Notation (BPMN).

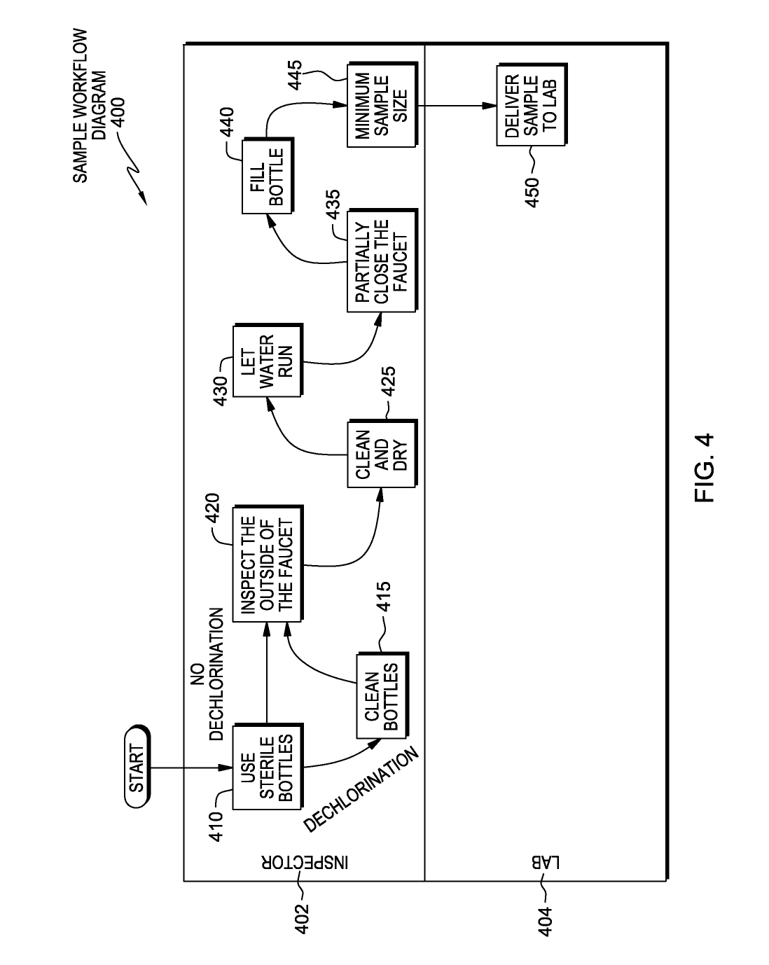

FIG. 4 illustrates an exemplary instance of workflow diagram 136. Sample workflow diagram 400 is an exemplary graphical depiction (e.g., BPM graphical workflow diagram in XPDL, BPEL, and BPMN) of sample operational manual 300. In exemplary embodiments, conversion program 200 utilizes sample operational manual 300 to generate sample workflow diagram 400, in accordance with embodiments of the present invention. In exemplary embodiments, storage device 132 includes an instance of workflow diagram 136 corresponding to each individual business process included in operational manual 134 that has been processed by conversion program 200. Application 116 (via input through user interface 114) on client device 110 can access operational manual 134 and workflow diagram 136 to provide revisions, annotations, other operations in accordance with embodiments of the present invention.

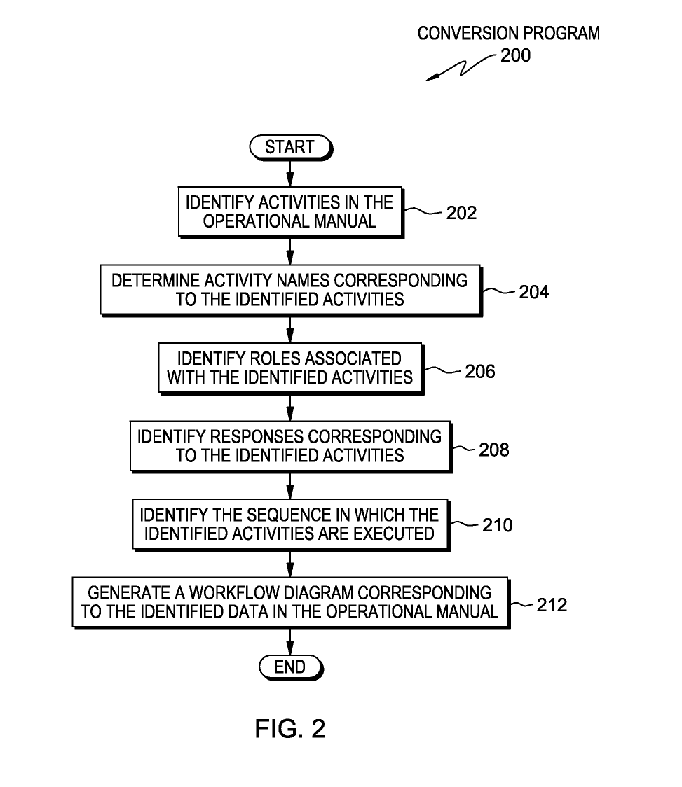

FIG. 2 is a flowchart depicting operational steps of conversion program 200 in accordance with an exemplary embodiment of the present invention. In one embodiment, conversion program 200 initiates responsive to application 116 (via input through user interface 114) requesting to generate a workflow diagram (i.e., workflow diagram 136) from an operational manual 134 on server 130 (or a section of operational manual 134). For example, conversion program 200 initiates responsive to application 116 requesting to convert a section of operational manual 134 (e.g., sample operational manual 300) to workflow diagram 136.

Conversion program 200 identifies activities in the operational manual (step 202). The identified activities correspond to steps of a business process described in operational manual 134. Activities can be described in different paragraphs of operational manual 134, and may be numbered or bulleted. In one embodiment, conversion program 200 receives configuration parameters from application 116, which indicate whether activities are in the format of separate paragraphs, bullets, numbering, or describe another marking which separate activities within operational manual 134. In another embodiment, conversion program 200 can utilize text analytics (i.e., Natural Language Processing (NLP)) to identify verbs and phrases in operational manual 134, which correspond to activities. For example, conversion program 200 can utilize NLP to identify root forms of verbs, and if/then conditions.

FIG. 3B illustrates sample identified activities 350, which includes activities 355. Activities 355 are the activities of steps of sample operational manual 300, which have been identified by conversion program 200. In an exemplary embodiment, conversion program 200 identifies nine activities in sample operational manual 300 (i.e., activities 355 in sample identified activities 350). Since step 1 of sample operational manual 300 includes an “if condition,” conversion program 200 identifies two activities within step 1 of sample operational manual 300, and therefore nine total activities 355 (as depicted in FIG. 3B).

Conversion program 200 then determines activity names corresponding to the identified activities (step 204). In one embodiment, for each activity identified in step 202, conversion program 200 determines an activity name that corresponds to the identified activity of operational manual 134, wherein the determined activity name includes the subject and verb (or root form of the verb) of the identified activity. After determining an activity name, conversion program 200 associates the determined activity name with the corresponding identified activity. In an exemplary embodiment, conversion program 200 determines activity names (e.g., subject and verb) in the first sentence of each identified activity utilizing NLP and Unstructured Information Management Architecture (UIMA) annotators. For example, conversion program 200 identified step 2 of sample operational manual 300 to be the third activity of sample operational manual 300 (depicted as Activity 3 in activities 355 of sample identified activities 350). In this example, conversion program 200 determines the activity name of Activity 3 to be “inspect the outside of the faucet.” In another embodiment, conversion program 200 utilizes NLP to analyze all text in an identified activity, and determines multiple possible activity names (e.g., subject and verb combinations). In this embodiment, conversion program 200 can prompt application 116 on client device 110 for a determination of an activity name, which can be received via input through user interface 114 to application 116.

In another exemplary embodiment, application 116 (via input through user interface 114) can provide modifications to operational manual 134 in the form of bolding, italicizing, underlining, or other indications as to which words in operational manual 134 correspond to an activity name. In this embodiment, conversion program 200 can utilize NLP to determine the text sections indicated by application 116 as activity names corresponding to identified activities (from step 202). Application 116 can provide preferences to conversion program 200, which can specify how conversion program 200 determines activity names. For example conversion program 200 can determine activity names to be complete sentences instead of subject verb combinations. In another example, conversion program 200 can prompt application 116 for a determination of an activity name, utilizing verbs as the activity names, utilizing nouns as the activity names, or other activity name determination preferences.

Conversion program 200 then identifies roles associated with the identified activities (step 206). In one embodiment, for each activity identified in step 202, conversion program 200 identifies roles that are associated with the identified activity of operational manual 134, wherein the roles are business roles that are associated with actors that perform the identified activities (e.g., individuals or business areas). In exemplary embodiments, application 116 can provide a list of business roles associated with operational manual, or operation manual 134 can include a list of business roles and responsibilities. When operational manual 134 includes a list of business roles and responsibilities, application 116 can provide an indication to conversion program 200 as to which section of operational manual 134 includes the list. Conversion program 200 can utilize a list of business roles to create a list of UIMA annotators to apply to operational manual 134 for identifying roles. If an identified activities text does not includes a role, then conversion program 200 can prompt application 116 for an indication of a role.

In the previously discussed example with regard to sample operational manual 300, operational manual 134 includes a list of business roles associated with actors that perform the process of sample operational manual 300, which includes business roles of “Inspector” and “Lab.” In this example, application 116 (via input through user interface 114) indicates that activities without an identifiable role are to be assigned to “Inspector.” Conversion program 200 identifies that activities one through eight correspond to the role of “Inspector”, and that activity nine corresponds to the role of “Lab” (identified activities depicted in sample identified activities 350). In another exemplary embodiment, application 116 (via input through user interface 114) can provide modifications to operational manual 134 in the form of bolding, italicizing, underlining, or other indications as to which words in operational manual 134 correspond to a business role. In this embodiment, conversion program 200 can utilize NLP to identify the text sections indicated by application 116 as business roles corresponding to identified activities (from step 202).

Conversion program 200 then identifies responses corresponding to the identified activities (step 208). In one embodiment, conversion program 200 utilizes NLP to identify activities in operational manual 134 that include an “if condition,” which indicate activities with responsive steps. Conversion program 200 can utilize a UIMA annotator that identifies “if conditions” (e.g., if<condition> then <action>) to analyze operational manual 134. An “if condition” can lead to multiple responses (e.g., a decision step with “yes” and “no” branches, if <condition> then <action> otherwise <action>, etc.). In the previously discussed example with regard to sample operational manual 300, conversion program 200 identifies activity one to include an “if condition” of “If dechlorination of sample is necessary” (illustrated in sample identified activities 350). In this example, conversion program 200 identifies activity two to be responsive to activity one. Since activity two is the only response to activity one in sample operational manual 300, conversion program 200 identifies activity three as the negative response of activity one (dechlorination not necessary). In exemplary embodiments, when an activity containing an “if condition” has a single response, conversion program 200 identifies (or application 116 provides) a corresponding alternate (i.e. negative or positive) response, which is opposite the single response.

Conversion program 200 then identifies the sequence in which the identified activities are executed (step 210). In one embodiment, conversion program 200 identifies the sequence of the identified activities (e.g., sample identified activities 350) of operational manual 134. In exemplary embodiments, the sequence in which the identified activities are executed corresponds to the order in which the activities are organized within the text of operational manual 134. In other embodiments, certain words are commonly utilized to indicate when to skip activities, or repeat activities (e.g., “go to”, “skip”, “advance to”, “repeat”, etc.), and indicate a specific sequence. NLP text analytics can utilize a UIMA annotator for identifying words that indicate a specific sequence. Conversion program 200 utilizes responses identified in step 208 to identify the sequence. In the previously discussed example, with regard to sample operational manual 300, conversion program 200 identifies the sequence in which the identified activities are executed to be the responses identified in step 208, and the remaining activities in the sequential order (three through nine). In this example, conversion program 200 can utilize coding in an application programming interface (API) to represent the sequence as:

createSequenceOnResponse (Activity1, “dechlorination of sample is necessary”, Activity2);

createSequenceOnResponse (Activity1, “dechlorination of sample is not necessary”, Activity3);

createSequence (Activity2, Activity3);

createSequence (Activity3, Activity4);

createSequence (Activity4, Activity5);

createSequence (Activity5, Activity6);

createSequence (Activity6, Activity7);

createSequence (Activity7, Activity8);

createSequence (Activity8, Activity9).

In another embodiment, conversion program 200 can prompt application 116 to provide a determination of a sequence in which the identified activities are executed. For example, conversion program 200 prompts application to provide a determination of “connect <source activity> to <target activity>”, wherein application 116 indicates which activities correspond to <source activity> and <target activity> (e.g., connect <Activity3> to <Activity4>). Conversion program 200 can present a list of available activities corresponding to <source activity> to <target activity> in a drop down lost for selection by application 116 (via input through user interface 114).

Conversion program 200 then generates a workflow diagram corresponding to the identified data in the operational manual (step 212). In one embodiment, conversion program 200 utilizes all the identified data corresponding to operational manual 134 (i.e. activities, activity names, roles, responses, sequence in which the identified activities are executed), to generate workflow diagram 136. Conversion program 200 generates a workflow diagram in a standard BPM representation (e.g., XPDL, BPEL, and BPMN). In another embodiment, application 116 (via input through user interface 114) can modify the generated workflow diagram (e.g., adjusting the sequence, add deadlines or other additional properties, etc.). In exemplary embodiments, conversion program 200 utilizes identified data from sample operational manual 300 to generate sample workflow diagram 400. For example, conversion program 200 utilizes identified roles (step 206) for the rows of inspector 402 and lab 404 in sample workflow diagram 400, and each activity box within sample workflow diagram 400 corresponds to an identified activity (step 202) and the activity names corresponding to the identified activity (step 204). When generating sample workflow diagram 400, conversion program 200 generates an activity box corresponding to each identified activity of sample operational manual 300 (identified in step 202), including the determined activity name (step 204) and located in the corresponding identified role (step 206). For example, conversion program 200 generates activity box clean and dry 425 corresponding to activity 4 (sample identified activities 350), which includes the determined activity name of “clean and dry” and is located in the row of inspector 402. Conversion program 200 arranges the identified activity boxes in the sequence identified in steps 208 and 210. In another embodiment, the activity names may be different than depicted in sample workflow diagram 400, corresponding to preferences which application 116 may provide (in step 204).

FIG. 5 depicts a block diagram of components computer 500, which is representative of client device 110 and server 130 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computer 500 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media. Software and data 522 are stored in persistent storage 508 for access and/or execution by processors 504 via one or more memories of memory 506. With respect to client device 110, software and data 522 represents application 116. With respect to server 130, software and data 522 represents conversion program 200, operational manual 134, and workflow diagram 136.

In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Software and data 522 may be downloaded to persistent storage 508 through communications unit 510.

I/O interface(s) 512 allows for input and output of data with other devices that may be connected to computer 500. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data 522 can be stored on such portable computer-readable storage media and can be loaded onto persistent storage 508 via I/O interface(s) 512. I/O interface(s) 512 also can connect to a display 520.

Display 520 provides a mechanism to display data to a user and may be, for example, a computer monitor. Display 520 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1-7. (canceled)

8. A computer program product for generating a workflow diagram corresponding to text describing a business process, the computer program product comprising:
one or more computer-readable storage media and program instructions stored on the one or more computer-readable storage media, the program instructions comprising:
program instructions to identify activities in steps of a business process by parsing text describing the business process;
program instructions to determine activity names associated with the identified activities;
program instructions to identify roles associated with actors performing the identified activities;
program instructions to identify a sequence in which the identified activities are executed; and
program instructions to generate a workflow diagram of the business process based on the identified activities, determined activity names corresponding to the identified activities, identified roles associated with the identified activities, and the identified sequence in which the identified activities are executed.

9. The computer program product of claim 8, wherein the program instructions to determine activity names associated with the identified activities, comprise program instructions to:
identify one or more subject and verb combinations within text of each of the identified activities; and
assign an activity name based on one of the identified subject and verb combinations.

10. The computer program product of claim 8, wherein the program instructions to identify roles associated with actors performing the identified activities, comprise program instructions to:
identify a listing of roles corresponding to the business process; and
determine a role in the identified listing of roles that corresponds to each of the identified activities.

11. The computer program product of claim 8, wherein the program instructions to identify a sequence in which the identified activities are executed, comprise program instructions to:
identify responsive activities, wherein the business process text describing the responsive activities includes an indication that the responsive activity is executed responsive to another identified activity; and
identify a sequence in which the identified activities are executed utilizing identified responsive activities and a sequential ordering of identified activities described within text of the business process.

12. The computer program product of claim 8, wherein the generated workflow diagram of the business process is in Business Process Management (BPM) graphical notation.

13. The computer program product of claim 8, further comprising program instructions to:
identify data within the text of the business process utilizing Natural Language Processing (NLP) and Unstructured Information Management Architecture (UIMA) annotators.

14. The computer program product of claim 8, wherein the text of the business process includes indications providing identification of activities of steps in the business process, activity names associated with activities, roles associated with activities, and a sequence in which activities are executed.

15. A computer system for generating a workflow diagram corresponding to text describing a business process, the computer system comprising:
one or more computer processors;
one or more computer-readable storage media;
program instructions stored on the computer-readable storage media for execution by at least one of the one or more processors, the program instructions comprising:
program instructions to identify activities in steps of a business process by parsing text describing the business process;
program instructions to determine activity names associated with the identified activities;
program instructions to identify roles associated with actors performing the identified activities;
program instructions to identify a sequence in which the identified activities are executed; and
program instructions to generate a workflow diagram of the business process based on the identified activities, determined activity names corresponding to the identified activities, identified roles associated with the identified activities, and the identified sequence in which the identified activities are executed.

16. The computer system of claim 15, wherein the program instructions to determine activity names associated with the identified activities, comprise program instructions to:
identify one or more subject and verb combinations within text of each of the identified activities; and
assign an activity name based on one of the identified subject and verb combinations.

17. The computer system of claim 15, wherein the program instructions to identify roles associated with actors performing the identified activities, comprise program instructions to:
identify a listing of roles corresponding to the business process; and
determine a role in the identified listing of roles that corresponds to each of the identified activities.

18. The computer system of claim 15, wherein the program instructions to identify a sequence in which the identified activities are executed, comprise program instructions to:
identify responsive activities, wherein the business process text describing the responsive activities includes an indication that the responsive activity is executed responsive to another identified activity; and
identify a sequence in which the identified activities are executed utilizing identified responsive activities and a sequential ordering of identified activities described within text of the business process.

19. The computer system of claim 15, further comprising program instructions to:
identify data within the text of the business process utilizing Natural Language Processing (NLP) and Unstructured Information Management Architecture (UIMA) annotators.

20. The computer system of claim 15, wherein the text of the business process includes indications providing identification of activities of steps in the business process, activity names associated with activities, roles associated with activities, and a sequence in which activities are executed.
